(19) United States
(12) Patent Application Publication
(10) Pub. No.: US 2012/0142396 A1
(43) Pub. Date: Jun. 7, 2012

(54) ANTENNA DEVICE FOR PORTABLE TERMINAL AND OPERATION METHOD THEREOF

(75) Inventor: Taek-Kyun Choi, Suwon-si (KR)

(73) Assignee: SAMSUNG ELECTRONICS CO., LTD., Suwon-si (KR)

(21) Appl. No.: 13/312,384

(22) Filed: Dec. 6, 2011

(30) Foreign Application Priority Data
Dec. 6, 2010 (KR) 10-2010-0123234

(51) Int. Cl. H04W 88/06; H04W 36/36

(52) U.S. Cl. 455/525; 455/73; 455/552.1

(57) ABSTRACT

An antenna device for a mobile communication terminal includes three antennas, a first RF module unit, a second RF module unit, and a control unit. The RF module unit is configured to communicate a signal of a first communication service through the first antenna. The second RF module unit is configured to communicate a signal of a second communication service through the second antenna. The control unit is configured to connect the third antenna to the first RF module unit or the second RF module unit selectively according to a selected communication service, operate the first and third antennas as a diversity antenna for the first communication service, and operate the second and third antennas as a MIMO antenna for the second communication service.

### CROSS-REFERENCE TO RELATED APPLICATION AND CLAIM OF PRIORITY

The present application is related to and claims priority under 35 U.S.C. §119(a) to a Korean Patent Application filed in the Korean Intellectual Property Office on Dec. 6, 2010 and assigned Serial No. 10-2010-0123234, the contents of which are herein incorporated by reference.

### TECHNICAL FIELD OF THE INVENTION

The present invention relates generally to an antenna device for a portable terminal. More particularly, the present invention relates to an antenna device for operating a diversity antenna or a Multiple-Input Multiple-Output (MIMO) antenna selectively by a small number of antennas and an operation method thereof.

### BACKGROUND OF THE INVENTION

Recently, with the development of the electronic communication industry, portable terminals have become important information communication devices and necessary articles of modern persons. Accordingly, service providers and terminal manufacturers are competitively developing portable terminals with more convenient functions in order to attract more users. For example, the portable terminals provide various communication services such as GSM, PCS, Bluetooth, DMB, WLAN, WiBro, LTE, WiMax, and 802.11n. In order to support such various communication services, the portable terminals are mounted with a plurality of antennas supporting different frequency bands.

Various multimedia services are required, and the communication capacity of communication systems increases accordingly. Therefore, an increasing interest is taken in an antenna technique for satisfying the communication capacity and reliability. Examples of such an antenna technique include a Multiple-Input Multiple-Output (MIMO) antenna technique and a diversity antenna technique. In the MIMO antenna technique, a base station and a portable terminal each uses two or more antennas to transmit data through various paths, and a receiving side detects signals received through the respective paths. In the diversity antenna technique, two or more antennas are used to receive radio signal waves, and the outputs thereof are combined to detect a received signal. The MIMO and diversity antennas can increase the reliability of data transmitted through antennas, and can overcome a limitation in the transmission capacity of mobile communication due to the expansion of data communication. However, it is difficult to install such antennas in a limited space. For example, if a spacing distance between the antennas is insufficient, the antenna performance may degrade due to a mutual interference between the antennas.

### SUMMARY OF THE INVENTION

To address the above-discussed deficiencies of the prior art, it is a primary aspect of the present disclosure to solve at least the above-mentioned problems and/or disadvantages and to provide at least the advantages described below. Accordingly, an aspect of the present disclosure is to provide an antenna device for slimming (or reducing a size of) a portable terminal.

Another aspect of the present disclosure is to provide an antenna device for operating a diversity antenna or a MIMO antenna by a minimum (or reduced) number of antennas and an operation method thereof.

Further another aspect of the present disclosure is to provide an antenna device for a portable terminal, which uses a diversity antenna or a MIMO antenna selectively according to desired communication services, and an operation method thereof.

Still another aspect of the present disclosure is to provide an antenna device for a portable terminal, which uses a diversity antenna or a MIMO antenna selectively according to a handover between heterogeneous networks, and an operation method thereof.

In accordance with an aspect of the present disclosure, an antenna device for a mobile communication terminal is provided. The antenna includes three antennas, an RF module unit for communicating a signal of a first communication service through the first antenna; a second RF module unit for communicating a signal of a second communication service through the second antenna, and a control unit for connecting the third antenna to the first RF module unit or the second RF module unit selectively according to a selected communication service, operating the first and third antennas as a diversity antenna for the first communication service, and operating the second and third antennas as a MIMO antenna for the second communication service.

In accordance with an another aspect of the present disclosure, a method for operating a diversity antenna or a MIMO antenna for a portable terminal, which has default antennas for communicating signals of first and second communication services respectively and auxiliary antennas used selectively together with the corresponding default antennas, is provide. The method includes detecting a selected communication service, determining whether a signaling connection with a selected communication service network is requested; determining whether a signaling connection message is received from the selected communication service network after the signaling connection request, and switching the auxiliary antenna to be used together with the default antenna corresponding to the selected communication service, when a signaling connection message is received from the selected communication service network.

In accordance with an further another aspect of the present disclosure, a method for operating a diversity antenna or a MIMO antenna for a portable terminal, which has default antennas for communicating signals of first and second communication services respectively and auxiliary antennas used selectively together with the corresponding default antennas, is provide. The method includes scanning a signal from a neighbor base station to determine a handover between heterogeneous networks, and switching the auxiliary antenna to be used together with the default antenna corresponding to a selected communication service, when a handover between heterogeneous networks is determined.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a portable terminal according to an exemplary embodiment of the present disclosure;

FIG. 2 illustrates a process for operating a diversity antenna or a MIMO antenna selectively according to use environments by a portable terminal having an antenna device according to an exemplary embodiment of the present disclosure;

FIG. 3A illustrates an example of a handover of a portable terminal between heterogeneous networks; and

FIG. 3B illustrates a process for operating a diversity antenna or a MIMO antenna selectively according to a handover between heterogeneous networks by a portable terminal according to an exemplary embodiment of the present disclosure.

### DETAILED DESCRIPTION OF THE INVENTION

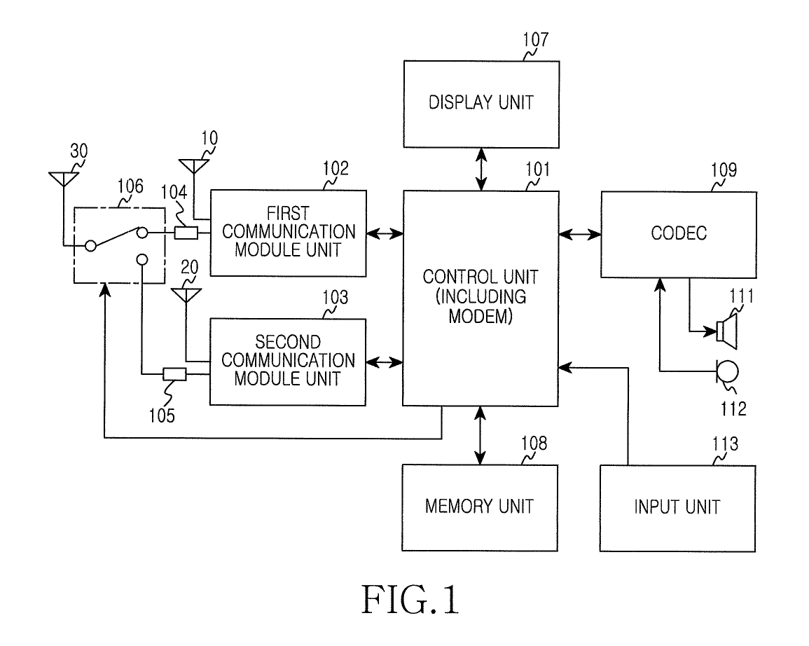

FIGS. 1 through 3B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communications system. Preferred embodiments of the present invention will be described herein below with reference to the accompanying drawings. In the following description, detailed descriptions of well-known functions or configurations will be omitted since they would unnecessarily obscure the subject matters of the present invention. Also, the terms used herein are defined according to the functions of the present invention. Thus, the terms may vary depending on users' or operators' intentions or practices. Therefore, the terms used herein must be understood based on the descriptions made herein.

The present disclosure relates to an antenna device for a portable terminal, and in particular, to an antenna device for operating a diversity antenna or a MIMO antenna by a small number of antennas selectively according to use environments and an operation method thereof. In one example, a portable terminal according to one embodiment of the present disclosure can operate a diversity antenna in a CDMA communication service and operate a MIMO antenna in a WiBro communication service.

FIG. 1 illustrates a portable terminal according to an exemplary embodiment of the present disclosure.

Referring to FIG. 1, a control unit 101 includes a modem for processing TX/RX signals of module units 102 and 103. The module units 102 and 103 may be an RF module unit configured to separately process operations for antennas.

A portable terminal according to an exemplary embodiment of the present disclosure includes a first (default) antenna 10 for communicating signals in a first frequency band, and a second (default) antenna 20 for communicating signals in a second frequency band. The portable terminal further includes a third (auxiliary) antenna 30 that is selectively connected to the first antenna 10 or the second antenna 20 to operate as a diversity antenna or a MIMO antenna.

The first antenna 10 is electrically connected to the first RF module unit 102 communicating signals of a first communication service, and the second antenna 20 is electrically connected to the second RF module unit 103 communicating signals of a second communication service. The first antenna 10 and the second antenna 20 operate as default antennas of the first and second module units 102 and 103 respectively.

The control unit 101 may select and use one of the first communication module unit 102 and the second communication module unit 103. In general, the control unit 101 uses a communication channel of the first communication module unit 102 and interrupts a communication channel of the second communication module unit 103. This may be set differently according to the terminal environments of a user. For example, when the user selects a CDMA communication service, the control unit 101 may enable the first communication module unit 102 and disable the second communication module unit 103. When a CDMA communication service is selected, the first communication module unit 102 is enabled and prepares to communicate signals through the selected default antenna, that is, the first antenna 10. Thereafter, when a signaling connection is established with a CDMA communication service network, the auxiliary antenna 30 is switched to the first communication module unit 102. Thus, by using a diversity antenna implemented using the first antenna 10 and the auxiliary antenna 30, the first communication module unit 102 can perform smoother signal communication in a CDMA communication service as compared to the conventional method. The auxiliary antenna 30 may maintain the switching state until a change to other communication service, or may return to the previous switching state upon termination of the signaling connection with the CDMA communication service network. For example, in the example of a mobile phone, when the user selects a CDMA communication service and presses a network connection button (e.g., a call button), the auxiliary antenna 30 is switched to be used together with the default antenna 10 for the CDMA communication service, the auxiliary antenna 30 may maintain the switching state until a change to other communication service even when the call is completed. In another exemplary embodiment, the auxiliary antenna 30 may return to the previous switching state when the call is completed. Initially, the auxiliary antenna 30 may be in a neutral state or may be switched to the preferred communication module unit.

The third antenna 30 is switched by a switching device 106 to the first antenna 10 or the second antenna 20. The switching device 106 is controlled by the control unit 101. The switching device 106 may be provided on a power supply line of the third antenna 30.

The control unit 101 may control the switching device 106 according to the terminal use environments of the user. For example, if the portable terminal performs a CDMA communication service, the control unit 101 may control the first RF module unit 102 to communicate signals of a CDMA communication service through the first antenna 10. Specifically, the control unit 101 controls the switching device 106 to electrically connect the third antenna 30 to the first RF module unit 102. Accordingly, the first RF module unit 102 can perform a CDMS communication service more smoothly by using the first antenna 10 and the third antenna 30 as a diversity antenna. Also, if the portable terminal performs a WiBro communication service, the control unit 101 may control the second RF module unit 103 to communicate signals of a WiBro communication service through the second antenna 20. Specifically, the control unit 101 controls the switching device 106 to electrically connect the third antenna 30 to the second RF module unit 103. Accordingly, the second RF module unit 103 can perform a WiBro communication service more smoothly by using the second antenna 20 and the third antenna 30 as a MIMO antenna. Herein, it is assumed that the base station and the portable terminal uses a MIMO technique for the WiBro communication service. Examples of the MIMO communication service include WiBro, LTE, WiMax, and 802.11n.

That is, the portable terminal according to an exemplary embodiment of the present disclosure includes default antennas 10 and 20 for different communication services, and further includes an auxiliary antenna 30 that is selectively switched to the default antennas. Thus, a diversity antenna and a MIMO antenna are implemented to perform the selected communication service smoothly by using two antennas.

The portable terminal may further include matching circuits 104 and 105 for improving the antenna performance. The matching circuits 104 and 105 may include an inductor and a capacitor.

A display unit 107, a memory unit 108, a codec 109, an input unit 113, a microphone 111, and a speaker 112 are well-known components of the portable terminal, and thus a description thereof will be omitted for brevity.

The control unit 101 controls an overall operation of the portable terminal. A method for operating an antenna device by the control unit 101 according to an exemplary embodiment of the present disclosure will be described below in detail with reference to the accompanying drawings.

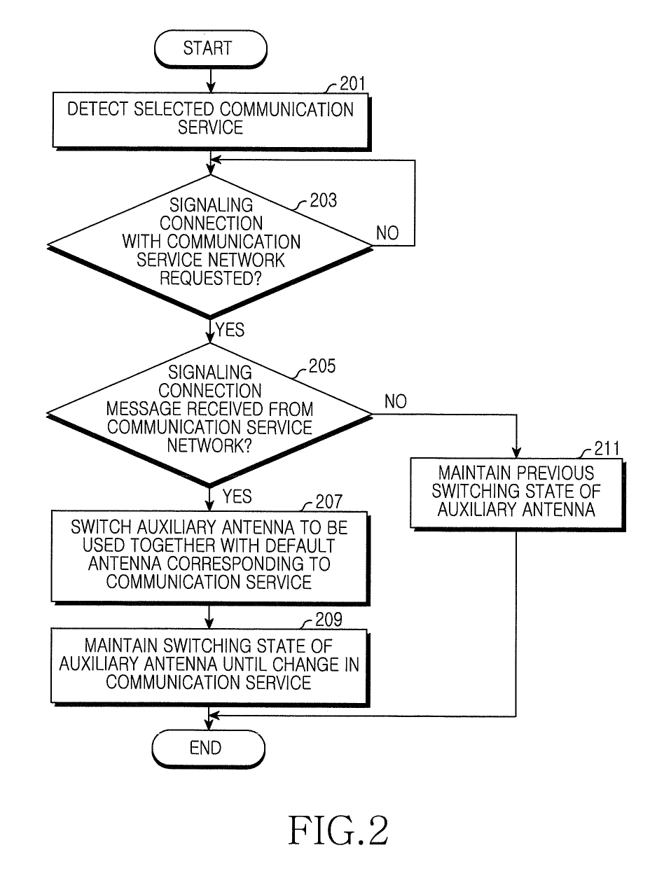

FIG. 2 illustrates a process for operating a diversity antenna or a MIMO antenna selectively according to use environments by a portable terminal having an antenna device according to an exemplary embodiment of the present disclosure.

Referring to FIG. 2, the control unit 101 detects a selected communication service in step 201. The user may select a communication service suitable for the terminal use environment.

In step 203, the control unit 101 determines whether a signaling connection with the selected communication service network is requested. In the example of a mobile phone, a call button is pressed to request a signaling connection with a base station.

If the signaling connection is requested, the control unit 101 proceeds to step 205. In step 205, the control unit 101 determines whether a signaling connection message is received from the selected communication service network. For example, the portable terminal may receive a call complete message from a base station for a 2G mobile communication service. Also, the portable terminal may receive a Radio Resource Control (RRC) message from a base station for a 4G mobile communication service.

If the signaling connection message is not received, the control unit 101 proceeds to step 211. In step 211, the control unit 101 maintains the previous switching state of the auxiliary antenna. The mobile phone cannot receive the signaling connection message if the mobile phone deviates from the selected communication service network or if the mobile phone is powered off.

On the other hand, if the signaling connection message is received, the control unit 101 proceeds to step 207. In step 207, the control unit 101 switches the auxiliary antenna 30 to be used together with the default antenna corresponding to the selected communication service. For example, in a 2G mobile communication service, the control unit 101 implements a diversity antenna by using both the auxiliary antenna and the selected default antenna, thus making it possible to perform smoother signal communication as compared to the example of using only the default antenna. Also, in a 4G mobile communication service, the control unit 101 implements a MIMO antenna by using both the auxiliary antenna and the selected default antenna, thus making it possible to perform smoother signal communication. The 2G and 4G mobile communication services are well known in the art, and thus a description thereof will be omitted for conciseness.

In step 209, the control unit 101 maintains the switching state of the auxiliary antenna until a change in the communication service.

However, the present disclosure is not limited thereto. When the signaling connection with the selected communication service network is terminated, the control unit 101 may return the auxiliary antenna to the previous switching state and return to step 203. For example, when a call button is pressed in the mobile phone, the auxiliary antenna 30 is switched to be used together with the selected default antenna. Thereafter, when the call is completed, the auxiliary antenna 30 returns to the previous switching state. Initially, the auxiliary antenna 30 may be in a neutral state or may be switched to the preferred communication module unit.

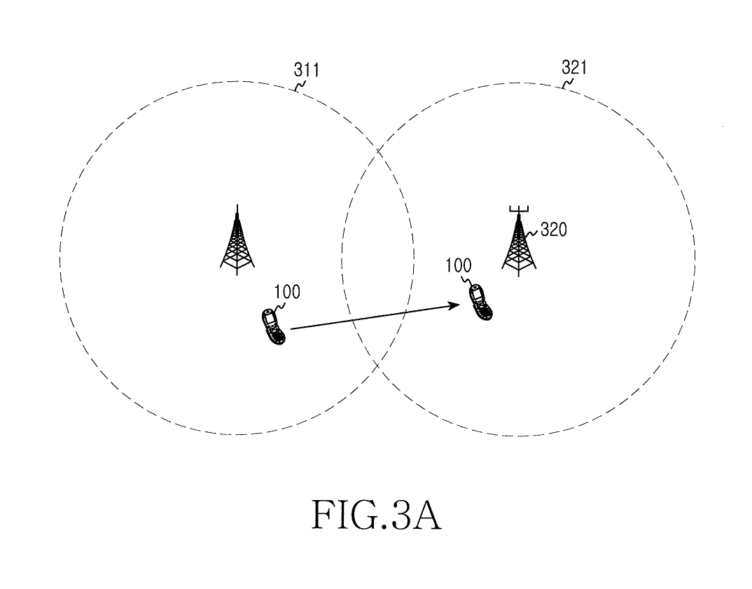

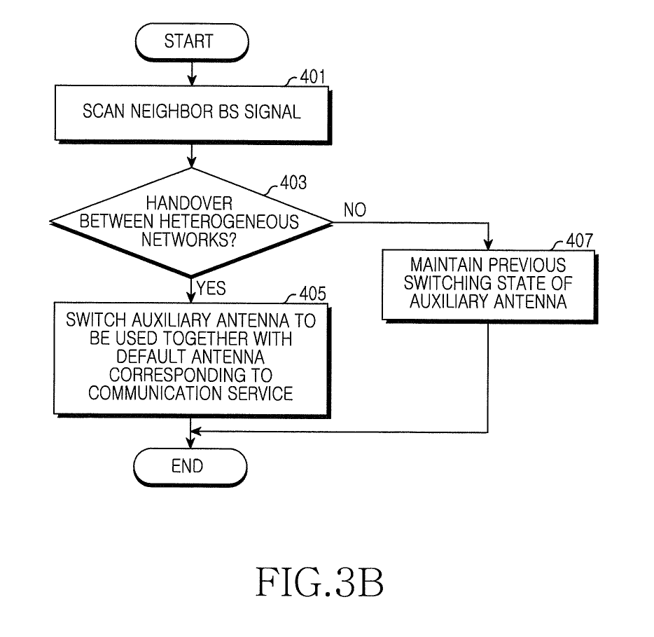

FIG. 3A illustrates an example of a handover of a portable terminal between heterogeneous networks. FIG. 3B illustrates a process for operating a diversity antenna or a MIMO antenna selectively according to a handover between heterogeneous networks by a portable terminal according to an exemplary embodiment of the present disclosure.

Referring to FIG. 3A, a portable terminal 100 deviates from a first communication service network 311 and is handed over to a second communication service network 321. This handover between heterogeneous networks is well known in the art, and thus a description thereof will be omitted for conciseness.

The portable terminal 100 communicates signals in the first communication service network 311 through a first default antenna 10 and an auxiliary antenna 30 that is switched to operate together with the first default antenna 10. Thereafter, the portable terminal 100 detects the handover to the second communication service network 321, and again switches the auxiliary antenna 30 to operate together with a second default antenna 20. Accordingly, the portable terminal 100 communicates signals in the second communication service network 321 through the selected default antenna 20 and the auxiliary antenna 30. For example, the first communication service network may be a 2G mobile communication service network, and the second communication service network may be a 4G mobile communication service network. Since the first default antenna 10 and the auxiliary antenna 30 are configured to operate as a diversity antenna in the 2G mobile communication service network, it is possible to perform smoother signal communication as compared to the example of using only the first default antenna 10. Also, since the second default antenna 20 and the auxiliary antenna 30 are configured to operate as a MIMO antenna in the 4G mobile communication service network, it is possible to perform smoother signal communication as compared to the example of using only the second default antenna 20. In this example, it is assumed that a base station 320 of the second service network 321 uses a MIMO technique.

Referring to FIG. 3B, the control unit 101 scans a neighbor base station signal in step 401.

In step 403, the control unit 101 determines a handover between heterogeneous networks. The handover between heterogeneous networks may be determined by the portable terminal or by the base station. The handover between heterogeneous networks is well known in the art, and thus a description thereof will be omitted for conciseness.

If the handover between heterogeneous networks is determined, the control unit 101 proceeds to step 405. In step 405, the control unit 101 switches the auxiliary antenna to be used together with the default antenna corresponding to the selected communication service. That is, a diversity antenna or a MIMO antenna may be implemented. For example, a diversity antenna may be implemented in the first communication service network 311, and a MIMO antenna may be implemented in the second communication service network 321.

On the other hand, if the handover between heterogeneous networks is not determined, the control unit 101 proceeds to step 407. In step 407, the control unit 101 maintains the previous switching state of the auxiliary antenna.

That is, when the handover between heterogeneous networks is determined, the auxiliary antenna 30 is automatically switched to operate together with the selected default antenna. In this example, the two module units 102 and 103 are always or periodically enabled to scan the neighbor base station signal by the selected default antenna, so that the control unit 101 can determine the handover between heterogeneous networks.

As described above, the antenna device of the present disclosure operates a diversity antenna or a MIMO antenna by a minimum (or reduced) number of antennas selectively according to use environments, thus making it possible to slim (or reduce a size of) portable terminals and provide smooth communication of service signals.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. An antenna device for a mobile communication terminal, comprising:
a first antenna;
a second antenna;
a third antenna;
a first Radio Frequency (RF) module unit configured to communicate a signal of a first communication service through the first antenna;
a second RF module unit configured to communicate a signal of a second communication service through the second antenna; and
a control unit configured to connect the third antenna to one of the first RF module unit and the second RF module unit selectively according to a selected communication service, operate the first and third antennas as a diversity antenna for the first communication service, and operate the second and third antennas as a Multiple-Input Multiple-Output (MIMO) antenna for the second communication service.

2. The apparatus of claim 1 further comprising:
a switch including a first node operably connected to the third antenna and a second node selectively connected to one of the first RF module unit and the second RF module.

3. The apparatus of claim 2, wherein the control unit is further configured to control the switch to connect the third antenna to one of the first RF module unit and the second RF module unit.

4. The apparatus of claim 1, wherein the control unit is further configured to switch the third antenna to be used together with one of the first and second antennas selectively according to the selected communication service when a signaling connection message is received from a communication service network.

5. The apparatus of claim 4, wherein the control unit is further configured to maintain a switching state of the third antenna until a change in a current communication service is detected.

6. The apparatus of claim 4, wherein the control unit is further configured to return the third antenna to a previous switching state when the signaling connection with the selected communication service network is terminated.

7. The apparatus of claim 4, wherein the control unit is further configured to maintain a previous switching state of the auxiliary antenna if the signaling connection message is not received from the selected communication service network.

8. The apparatus of claim 4, wherein the signaling connection message is one of a call complete message and a Radio Resource Control (RRC) connection message.

9. The apparatus of claim 1, wherein the control unit is further configured to scan a signal from a neighbor base station to determine a handover between heterogeneous networks, and switch the third antenna to be used together with one of the first and second antennas selectively according to the selected communication service, when a handover between heterogeneous networks is determined.

10. The apparatus of claim 1, wherein the control unit is further configured to maintain a previous switching state of the third antenna if a handover between heterogeneous networks is not determined.

11. A method for operating one of a diversity antenna and a Multiple-Input Multiple-Output (MIMO) antenna for a portable terminal, the method comprising:
detecting a selected communication service;
determining whether a signaling connection with a selected communication service network is requested;
determining whether a signaling connection message is received from the selected communication service network after the signaling connection request; and
switching an auxiliary antenna to be used together with a default antenna corresponding to the selected communication service when a signaling connection message is received from the selected communication service network,
wherein the portable terminal has default antennas for communicating signals of first and second communication services and the auxiliary antenna used selectively with one of the default antennas.

12. The method of claim 11 further comprising:
maintaining a switching state of the auxiliary antenna until a change in a current communication service is detected.

13. The method of claim 11 further comprising:
returning the auxiliary antenna to a previous switching state when the signaling connection with the selected communication service network is terminated.

14. The method of claim 11 further comprising:
maintaining a previous switching state of the auxiliary antenna if the signaling connection message is not received from the selected communication service network.

15. The method of claim 11, wherein the signaling connection message is one of a call complete message and a Radio Resource Control (RRC) connection message.

16. The method of claim 11, wherein switching the auxiliary antenna comprises:
operating the auxiliary antenna and the default antenna as a diversity antenna for a first communication service of the portable terminal.

17. The method of claim 11, wherein switching the auxiliary antenna comprises:
operating the second and third antennas as a Multiple-Input Multiple-Output (MIMO) antenna for a second communication service of the portable terminal.

18. A method for operating one of a diversity antenna and a Multiple-Input Multiple-Output (MIMO) antenna for a portable terminal, the method comprising:
scanning a signal from a neighbor base station to determine a handover between heterogeneous networks; and
switching an auxiliary antenna to be used together with a default antenna corresponding to a selected communication service, when a handover between heterogeneous networks is determined,
wherein the portable terminal has default antennas for communicating signals of first and second communication services and the auxiliary antenna used selectively with one of the default antennas.

19. The method of claim 18 further comprising:
maintaining a previous switching state of the auxiliary antenna if a handover between heterogeneous networks is not determined.

20. The method of claim 18 further comprising:
operating the auxiliary antenna and the default antenna as a diversity antenna in a first communication service network; and
operating the second and third antennas as a Multiple-Input Multiple-Output (MIMO) antenna in a second communication service network.
